(19) United States
(12) Patent Application Publication
(10) Pub. No.: US 2020/0346585 A1
(43) Pub. Date: Nov. 5, 2020

(54) SECUREMENT DEVICE FOR USE WITH A VEHICLE SEAT BELT BUCKLE

(71) Applicant: Jonathan Abbott, Scottsdale, AZ (US)

(72) Inventor: Jonathan Abbott, Scottsdale, AZ (US)

(21) Appl. No.: 16/402,809

(22) Filed: May 3, 2019

(51) Int. Cl. B60R 7/14; A44B 11/25

(52) U.S. Cl. CPC B60R 7/14; A44B 11/2503

(57) ABSTRACT

A securement device for use with a vehicle seat belt buckle. The device includes an integrated latch plate for insertion into a standard vehicle seat belt buckle. It also includes a retention point for attachment, via spring steel clip or other appropriate means, of a personal item such as a personal safety device, holstered smallarm, or related accessories. In alternate embodiments, the device may also incorporate a variety of multitool features and interwoven nylon kernmantle cord for noise reduction.

### FIELD OF THE INVENTION

A securement device particularly adapted and designed for use in a vehicle by insertion into any standard vehicle seat belt buckle which is not otherwise in regular use. The device is configured to releasably retain an object in connection with the device in a fixed location and position in the vehicle. The device may also incorporate a variety of multitool features and interwoven nylon kernmantle cord for noise reduction, but these elements are aesthetic or ergonomic enhancements, nonessential to the primary function and purpose of the device.

### BACKGROUND OF THE INVENTION

As the societal demand for expeditious access to a variety of personal safety devices accelerates, it becomes increasingly common for many individuals to carry such devices on their person, in open view or under concealment. These devices include knives, defensive sprays, smallarms, and smallarms accoutrements, for all of which there exists a variety of retention devices, holsters, and means of securement. For the mobile or peripatetic individual, these retention devices or holsters are designed for comfort and ease of access, but they all become decidedly less comfortable, accessible, or accommodatable when said individual is a driver or passenger in a vehicle. The myriad solutions for vehicle securement or storage all present various drawbacks and associated problems. Magnetic holster systems attract dirt and debris which can negatively affect the aesthetics or performance of the personal safety device. Strap and seat systems, constructed of nylon and other like materials, are bulky and cumbersome and often fail to secure the personal safety device into an immobile and determinable location. Many such devices necessitate permanent vehicle modification or compel permanent securement which does not allow for repositioning or removal without significant effort or residual damage. There is, therefore, a need for an improved securement device for use in a vehicle.

### DESCRIPTION OF THE PRIOR ART

Many aftermarket or third-party securement devices and systems, storage boxes, gun safes, and other similar or associated containment devices exist for use in vehicles, but these all appear to rely on other forms and locations of securement and placement within or attachment to the vehicle. Applicant is unaware of any prior art which associates a securement device with direct insertion into an otherwise unoccupied or unused vehicle seat belt buckle.

### SUMMARY OF THE INVENTION

The instant invention presents a securement device particularly created for use in any and all vehicles equipped with a seat belt buckle, covering the gamut from road-legal vehicles (automobiles, buses, motorhomes, etc.) to boats, forklift, and even tractors.

The invention is configured to provide secure retention as well as quick and easy release from retention while also allowing for placement in multiple positions and orientations within the vehicle.

Further objectives of the instant invention are to provide a securement device that can be quickly and easily located within the vehicle; that can be placed in and removed from the vehicle with ease, speed, and without necessity of tools or labor; that can be easily concealed, where desirable and allowable; and that may be utilized with myriad types of object retainers.

Other facets and advantages of this invention will be evident from the following detailed description when viewed in conjunction with the accompanying illustrations wherein are set forth, by example, certain embodiments of this invention.

### BRIEF DESCRIPTION OF THE FIGURES

FIG. 1 is a plan view of a securement device as described in claim 1.

FIG. 2a-2b is a plan view of two juxtaposed securement devices representing the embodiment as described in claim 4.

FIG. 3 is a plan view of a securement device representing the embodiment described in claim 5.

FIG. 4 is perspective view of securement device representing a particular embodiment of claim 6, wherein claim 2 through claim 5, inclusive, are incorporated into the particular embodiment.

### DETAILED DESCRIPTION OF THE INVENTION

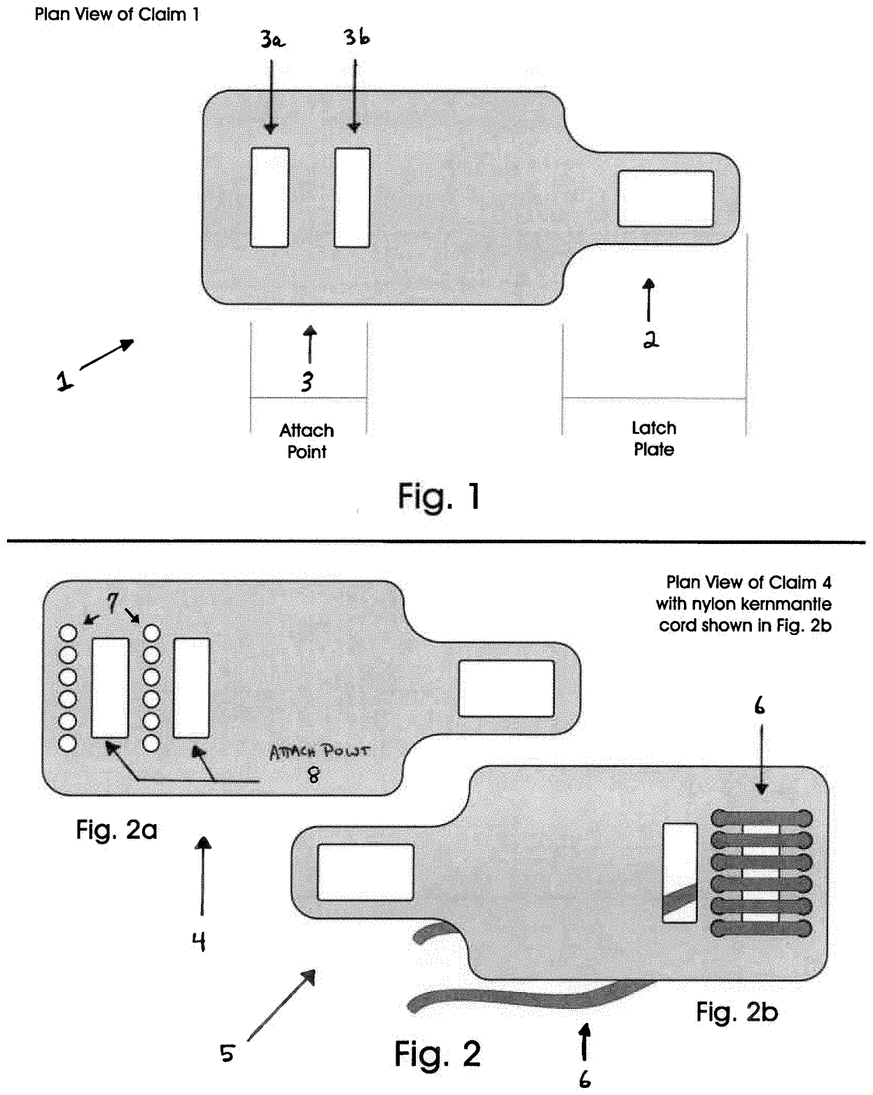

The reference numeral 1, in FIG. 1, represents, generally, a securement device for use in any vehicle (not shown) equipped with a standard seat belt buckle (not shown). In this context, a “standard” seat belt buckle refers to one adhering to the design of the so-called CIR-Griswold restraint commonly used in most consumer vehicles today, as described in U.S. Pat. No. 2,710,649, and manufactured in accordance with 49 CFR § 571.209—Standard No. 209 for seat belt assemblies. The securement device 1 is a rigid and durable device manufactured from any suitable material sufficient to support the weight of a personal item such as a smallarm or similar device (not shown) which does not otherwise exceed the weight limits imposed for seat belt assemblies under 49 CFR § 571.209—Standard No. 209. Suitable materials for manufacture of securement device 1 may include, but are not limited to, any metal, carbon fiber, or polycarbonate whether manufactured by means of laser cutting, water cutting, milling, casting, injection molding, or other appropriate methodology.

The securement device 1 integrally incorporates a seatbelt latch plate 2, which is appropriately manufactured and proportioned to insert and lock into any standard seat belt buckle. Antipodal to the seatbelt latch plate 2, at the opposite end of the securement device 1, two rectangular slots 3a and 3b constitute attach point 3, where a personal item (such as a holstered smallarm (not pictured)) can be attached by means of an integrated metal, plastic, spring steel, or similar clip (not pictured). The two rectangular slots 3a and 3b provide sufficient space for the jaws of any such clip to connect jaw-to-jaw through either rectangular slot 3a or 3b of attach point 3, thus allowing the clip to create a secure attachment to securement device 1. With the personal item attached via attach point 3 to securement device 1, and with latch plate 2 inserted into a standard seat belt buckle, the securement device 1 creates a secure bridge between the seat belt buckle and the personal item. The simplicity and bilateral symmetry of securement device 1 allow for insertion or attachment from either direction.

The reference numerals 4 and 5, as seen in FIG. 2, represent, generally, the embodiment of the securement device as described in claim 4, modified to accommodate the integration of interwoven nylon kernmantle cord 6 or comparable material, such that the interwoven cord 6 effects greater securement of the personal item (not shown) and elimination of noise associated with motion of the vehicle and imperfect contact between the securement device 4 and 5 and the metal clip on the personal item. The modification consists of two rows of aligned holes 7 (six holes are shown in each row in this embodiment, but a specific number of holes is neither prescribed or required for the functionality of the modification or the securement device 4 and 5) placed adjacent to the rectangular slots of attach point 8. Reference numeral 4 illustrates the modified securement device, whereas reference numeral 5 illustrates the modified securement device with interwoven cord 6. The cord may be interwoven in any means or manner sufficient to effect greater securement of the personal item and elimination of noise resultant from imperfect contact or attachment. The incorporation of an interwoven cord 6 as shown in FIG. 2 or elsewhere described does not alter the function and operation of securement device 4 and 5.

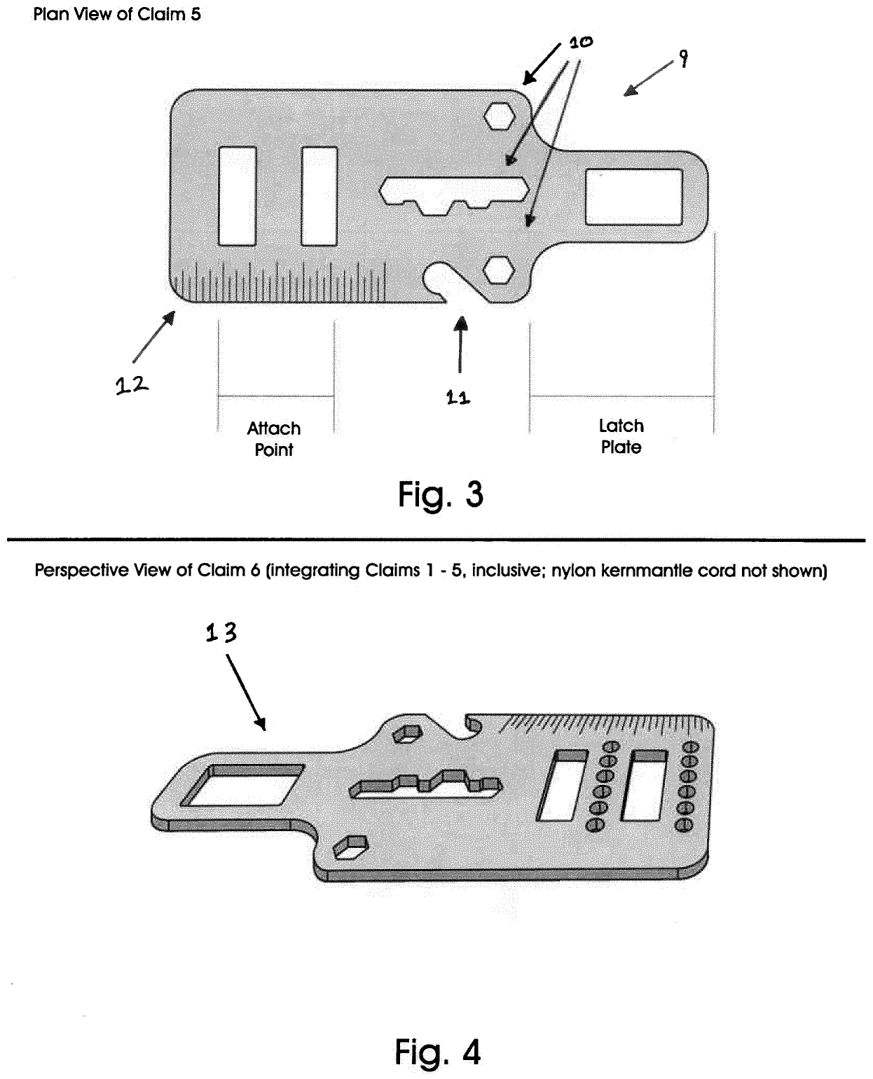

The reference numeral 9, generally, represents the embodiment of the securement device wherein the device is modified for integration of elements of a multitool. Specifically shown in this embodiment of securement device 9 are wrenches 10 of various sizes, a bottle opener 11, and a ruler 12, which may be printed, painted, etched, laser cut, or otherwise integrated into the securement device 9. Any incorporated elements of a multitool as shown in FIG. 3 or elsewhere described do not alter the function and operation of securement device 9.

The reference numeral 13 represents, generally, a particular embodiment of the securement device as described in claim 6, incorporating many of the modifications enumerated in the above claims 1-5.

It is to be understood that while certain forms and embodiments of the invention are illustrated in the accompanying FIGS. 1-4, inclusive, the invention is not to be construed as to be solely embodied as shown therein nor is it to be limited by any such form, arrangement, or specifications elsewhere illustrated or described herein. It will be apparent to any person having ordinary skill in the art that myriad changes in form and arrangement may be made to the invention without such changes resulting in departure from the scope of the invention.

It will be evident to a person having ordinary skill in the art that the instant invention is well designed and adapted to achieve the objectives and attain the results and advantages herein described as well as those that are inherent therein. Any embodiments, methods, means, procedures, and techniques described or illustrated herein are presently representative of certain preferred embodiments and are strictly intended to be exemplary and not as any expression of limitation on the scope of the invention or as a restriction of the invention to such specific embodiments. Changes and modifications to the invention and alternate uses for the invention may occur to those skilled in the art, all of which changes, modifications, or alternate uses are encompassed in the spirit and intent of the invention and are defined by and intended to be within the scope of the incorporated Claims.

1. A securement device for removable mounting in a vehicle seat belt buckle, said device comprising a formed singular metal or hardened plastic plate, approximately 0.1025″ thick, integrating a seat belt latch plate and an obversely positioned attachment point for further securement of a personal item by means of a metal clip or comparable form of attachment.

2. The securement device of claim 1, wherein the secured personal item is a personal safety device, holstered smallarm, or related items and accessories, including, but not limited to, knives, pepper sprays, tasers, and smallarm magazines, cylinders, and speed loaders.

3. The securement device of claim 1, wherein the device is painted or powder coated to effect a softer finish for aesthetic and ergonomic benefit.

4. The securement device of claim 1, wherein the device is modified for integration of interwoven nylon kernmantle cord or comparable material, such that the interwoven cord effects greater securement of the personal item and elimination of noise associated with motion of the vehicle and imperfect contact between the device and the metal clip or comparable form of attachment.

5. The securement device of claim 1, wherein the device is modified for integration of elements of a multitool, including, but not limited to, a bottle opener, knife, ruler, screwdriver, seat belt cutter, or wrench of any accommodatable size.

6. The securement device of claim 1, wherein any or all variants and modifications enumerated in the above claim 2 through claim 5, inclusive, are incorporated into the device, in any or all combinations thereof.
